(19) United States
(12) Patent Application Publication
(10) Pub. No.: US 2010/0245885 A1
(43) Pub. Date: Sep. 30, 2010

(54) Techniques For Printing To Hotspot Printers

(76) Inventor: Senthil K. Selvaraj, Snoqualmie, WA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/410,329

(22) Filed: Mar. 24, 2009

(51) Int. Cl. G06F 3/12

(52) U.S. Cl. 358/1.15

(57) ABSTRACT

Techniques are provided for printing an electronic document from a client device to printing devices that are registered with a server. The printing devices and device capabilities are retrieved from the server according to location criteria provided by a user. Through a user interface, users view the names, location, and print settings of printing devices that satisfy the location criteria, and maps and directions for the printing devices. Users also modify a printing device's print settings and select printing devices for printing. Users provide login information to login to the document server to retrieve available documents for printing. Print jobs are generated that reflect an electronic document selected by a user and print settings modified by the user and are submitted to a printing device selected by the user. Printing devices also provide user interfaces for users to retrieve electronic documents from document servers without use of a client device.

### FIELD OF THE INVENTION

The present invention relates to printers and print drivers.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Currently, there is no unified solution for users to print electronic documents at remotely located printing devices. For example, a user who wishes to print an electronic document as a spiral-bound book has to search for a print services provider that provides a printing device capable of printing spiral-bound books, locate the print services provider, and deliver the electronic document, along with any print settings customizations, to the print services provider. In order to perform these steps, the user will likely access several different software applications to search for and locate the print services provider, utilize the telephone network or the public network to communicate with the print services provider to inquire about the device capabilities of the printing devices at the print services provider, and physically deliver the electronic document to the print services provider, along with instructions containing print setting customizations. This is a tedious, multi-step process that requires much time and effort from users.

Also, there is no unified solution for users to print remotely located electronic documents at remotely located printing devices. For example, a user arrives at an airport and realizes that he forgot to print an electronic document for a meeting at the destination. The user wishes to print the electronic document at a printing device located near the destination, but does not have the electronic document on his laptop. However, the electronic document is located on a remote document server. Currently, there is no convenient way for the user to print the electronic document to a printing device located near the destination.

In another example, a user arrives at an airport and wishes to print a copy of his travel itinerary to a printing device located at the airport. The user does not have a laptop with him, but the travel itinerary is located on a remote server. Currently, however, there is no unified solution that allows the user to access and print the travel itinerary to the printing device located at the airport.

### SUMMARY

Printing devices register with a server and provide information to the server regarding the printing devices' physical location, IP address, and device capabilities. A user sends a request, through printer driver software installed on the user's client device (hereinafter, “printer driver”), to the server for information regarding available printing devices at or around a particular geographic location. In response, the server provides the requested information to printer driver, which includes identification of the available printing devices and the physical locations and device capabilities of the available printing devices. Based on the information provided by the server, the printer driver can access a map service to present map data to the user that indicates where the available printing devices are located. The printer driver can also display the available printing devices' device capabilities to the user as customizable print settings. The user selects a particular printing device from the available printing devices, customizes the print settings for the particular printing device, and indicates to the print driver that a particular electronic document is to be printed to the particular printing device using the customized print settings. In response, the print driver generates a print job for the particular electronic document, based on the customized print settings, and submits the print job to the particular printing device for printing.

According to one embodiment, users store electronic documents on document servers that are also registered with the server. The printer driver can communicate with the server to identify registered document servers. A user who wishes to print an electronic document that is stored on a document server provides authentication data (e.g., user name and password) to the printer driver, which then sends the authentication data to the document server. The document server, in response to receiving the authentication data, communicates to the printer driver which electronic documents on the document server are available to and can be printed by the user. The printer driver displays the identity of the available electronic documents to the user, who then selects a particular electronic document for printing. The printer driver downloads the particular electronic document from the document server. The user selects a printing device and customizes print settings as just described above. The printer driver generates a print job for the downloaded electronic document, based on the customized print settings, and submits the print job to the particular printing device for printing.

According to another embodiment where users store electronic documents on document servers that are registered with the server, a printing device provides a user interface through which a user may provide authentication data. The printing device communicates with the server to identify registered document servers. The printing device sends authentication data to a registered document server, and in response receives information regarding which electronic documents on the registered document server are available to the user for printing. The available documents are displayed to the user, and the user selects an electronic document for printing through the user interface. The selected electronic document is printed by the printing device.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts an example arrangement in which an embodiment of the invention may be implemented.

FIG. 2 depicts an example printer selection screen.

FIG. 3 depicts and example printing device selection screen.

FIG. 4 is a diagram that depicts a series of communications steps according to one embodiment of the invention.

FIG. 5 is a block diagram that depicts an example arrangement in which an embodiment may be implemented.

FIG. 6 depicts an example printer driver selection screen.

FIG. 7 depicts an example document selection screen.

FIGS. 8A and 8B are diagrams that depict a series of communications steps according to one embodiment of the invention.

FIG. 9 is a block diagram that depicts an example arrangement in which an embodiment may be implemented.

FIG. 10 depicts an example user interface panel.

FIG. 11 is a diagram that depicts a series of communications steps according to one embodiment of the invention.

FIG. 12 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

I. OVERVIEW

II. LOCATING AND PRINTING TO REMOTE PRINTING DEVICES

III. PRINTING REMOTE DOCUMENTS TO REMOTE PRINTING DEVICES

IV. PRINTING DIRECTLY AT A PRINTING DEVICE

V. IMPLEMENTATION MECHANISMS

### I. Overview

Printing devices register with a server and provide information to the server regarding the printing devices' physical location, IP address, and device capabilities. A user sends a request, through printer driver software installed on the user's client device (hereinafter, “printer driver”), to the server for information regarding available printing devices at or around a particular geographic location. In response, the server provides the requested information to printer driver, which includes identification of the available printing devices and the physical locations and device capabilities of the available printing devices. Based on the information provided by the server, the printer driver can access a map service to present map data to the user that indicates where the available printing devices are located. The printer driver can also display the available printing devices' device capabilities to the user as customizable print settings. The user selects a particular printing device from the available printing devices, customizes the print settings for the particular printing device, and indicates to the print driver that a particular electronic document is to be printed to the particular printing device using the customized print settings. In response, the print driver generates a print job for the particular electronic document, based on the customized print settings, and submits the print job to the particular printing device for printing.

According to one embodiment, users store electronic documents on document servers that are also registered with the server. The printer driver can communicate with the server to identify registered document servers. A user who wishes to print an electronic document that is stored on a document server provides authentication data (e.g., user name and password) to the printer driver, which then sends the authentication data to the document server. The document server, in response to receiving the authentication data, communicates to the printer driver which electronic documents on the document server are available to and can be printed by the user. The printer driver displays the identity of the available electronic documents to the user, who then selects a particular electronic document for printing. The printer driver downloads the particular electronic document from the document server. The user selects a printing device and customizes print settings as just described above. The printer driver generates a print job for the downloaded electronic document, based on the customized print settings, and submits the print job to the particular printing device for printing.

According to another embodiment where users store electronic documents on document servers that are registered with the server, a printing device provides a user interface through which a user may provide authentication data. The printing device communicates with the server to identify registered document servers. The printing device sends authentication data to a registered document server, and in response receives information regarding which electronic documents on the registered document server are available to the user for printing. The available documents are displayed to the user, and the user selects an electronic document for printing through the user interface. The selected electronic document is printed by the printing device.

### II. Locating and Printing to Remote Printing Devices

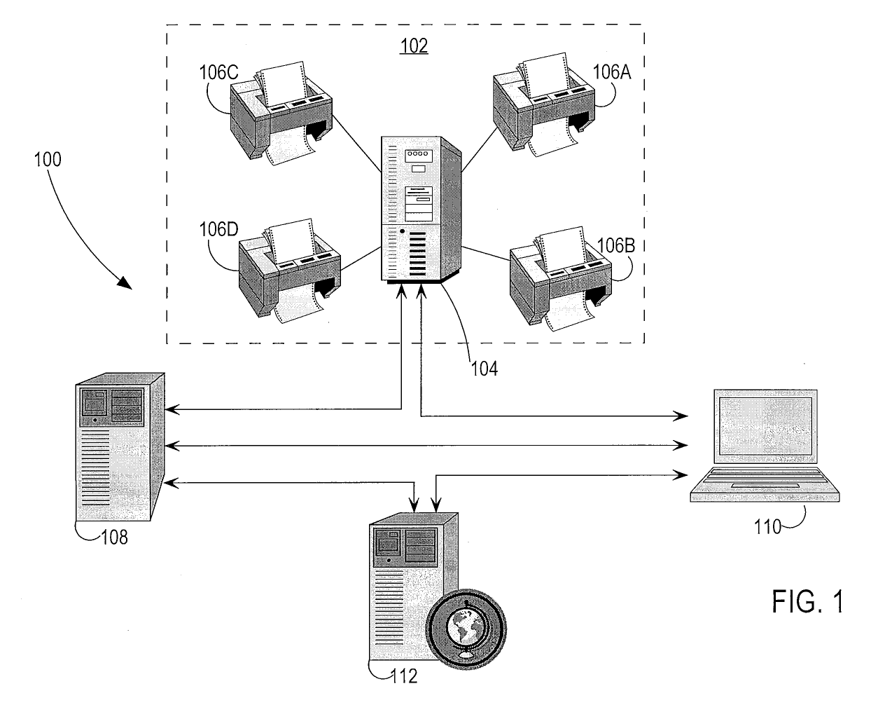

FIG. 1 is a block diagram that depicts an example arrangement 100 in which an embodiment of the invention may be implemented. Arrangement 100 includes a print services provider 102, a server 108, a map server 112, and a client device 110 that are communicatively coupled to each other via one or more communications links. The various elements depicted in FIG. 1 may also communicate with each other via a network that is not depicted in FIG. 1. The network may be implemented by any medium or mechanism that provides for the exchange of data between the various elements depicted in FIG. 1 Examples of the network include, without limitation, a network such as a Local Area Network (LAN), Wide Area Network (WAN), Ethernet or the Internet, or one or more terrestrial, satellite or wireless links. The network may also provide secure communications between the various elements depicted in FIG. 1.

In the example depicted in FIG. 1, print services provider 102 includes print server 104 and printing devices 106A, 106B, 106C, and 106D (collectively, the printing devices 106). The print server 104 accepts print jobs on behalf of the printing devices 106 and distributes the accepted print jobs to the printing devices 106. Printing devices 106 may be any type of device that is capable of processing print jobs and generating a printed version of electronic documents reflected in print jobs. Examples of printing devices 106 include, without limitation, printers, network-enabled copy machines and multi-function peripherals (MFPs), and the approaches described herein are not limited to any particular type of printing devices 106. Embodiments of the invention are described herein in the context of the four printing devices depicted in FIG. 1, but the approach is applicable to any number of printing devices disposed in the same or different physical location. In an alternative embodiment, a printing device may be directed communicatively coupled to server 108 and client 110 or the aforementioned network without the intermediate element of a print server 104 and without being included in a group of printing devices in a print services provider. In this alternative embodiment, a printing device is capable of accepting print jobs on its own behalf and processing the accepted print jobs.

Server 108 communicates with print server 104 to enable print server 104 to register printing devices (i.e., printing devices 106) with server 108. In an alternative embodiment, individual printing devices directly register with server 108. When a printing device is registered with server 108, information about the registering printing device is provided to the server 108. This information may include, for example, the printing device's IP address, device capabilities (e.g., duplex, stapler, color/black&white, hole punch, etc.), and physical location. In one embodiment, during registration, a printing device provides server 108 with information specifically requested by server 108. For example, server 108 may specifically request for the registering printing device's device capabilities.

Map server 112 is a repository of map data and provides map data to various elements (e.g., server 108 and client 110) upon request. Map server 112 may be owned or controlled by a map services provider, also referred to herein as “map service”, such as Google maps or MapQuest.

Client device 110 may be any type of client device, including, without limitation, a desktop computer, a laptop computer, a personal digital assistant (PDA), a mobile device and a telephony device. Client device 110 includes printer driver software (not depicted in FIG. 1), also referred to herein as “printer driver”, that manages communications with other elements in arrangement 100 to facilitate the printing of electronic documents to the printing devices 106. For example, client device 100 may communicate with server 108 to request information about the printing devices 106, communicate with map server 112 to request map data of a geographical area around printing device 106A, and communicate with print server 104 to submit a print job to the printing devices 106. The discussion below provides a detailed description of the techniques and processes for the client device 110 to print an electronic document to the printing devices 106.

According to one embodiment of the invention, the printer driver on a client device (e.g., client device 110) is configured to generate a graphical user interface that allows users to locate, access and print to printing devices (e.g., printing devices 106) that are registered with a server (e.g., server 108). The user interface may be implemented by any mechanism(s) and/or process(es) that allow for the exchange of information between the client device and users. Examples of user interface include, without limitation, a display, such as a cathode ray tube (CRT) or liquid crystal display (LCD), and an input device, such as a keypad, touchpad, touch screen, keyboard or mouse, or any combination of displays and input devices.

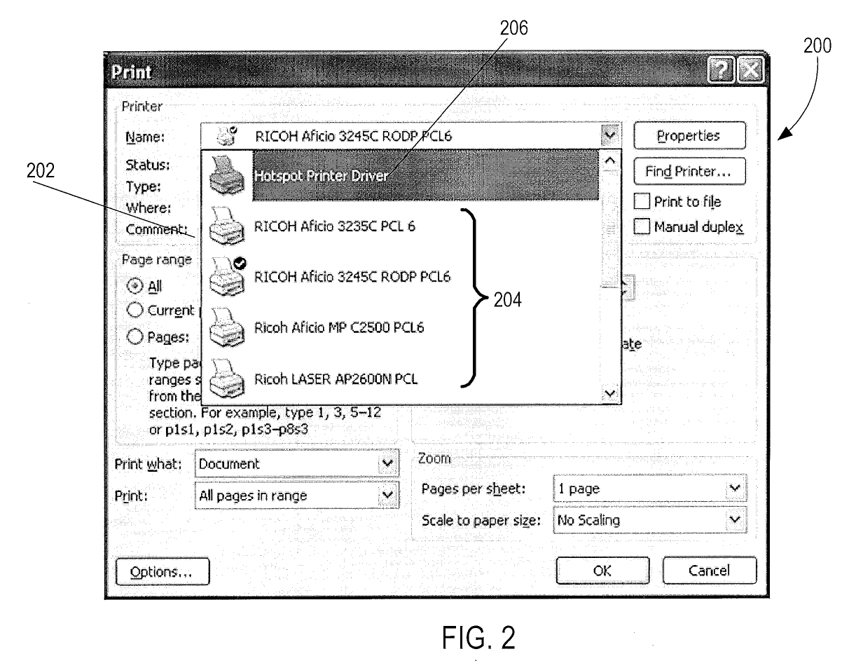

FIG. 2 depicts an example printer selection screen 200, a graphical user interface that is generated by a printer driver in response to a user issuing a print command. For example, the user may be using a photo-editing application on a client device and may have decided to print a particular photo (electronic documents, as described herein, include photographs). Printer selection screen 200 displays printer menu 202, a drop-down menu that lists the printers to which the user may print. The printers listed in printer menu 202 include printers 204 and “Hotspot Printer Driver” 206.

In this example, the user wishes to print the particular photo to a printer that has the capability to print photos on photographic paper, and knows that the printers 204 do not have this capability. The user selects “Hotspot Printer Driver” 206 to search for printing devices that do have this capability. In this example, the selection of “Hotspot Printer Driver” 206 is an indication that the user wishes to print to remotely located printing devices that are registered with a server. A user's desire to print to remotely located printing devices that are registered with a server may be indicated through a variety of different ways in other embodiments with different user interfaces. Remotely located printing devices are printing devices that are not already directly known and accessible by the client device, but which are registered with the server. As such, remotely located printing devices may also include printing devices that are on the same local network as the client device, but which are not already known by the client device and which have registered with the server.

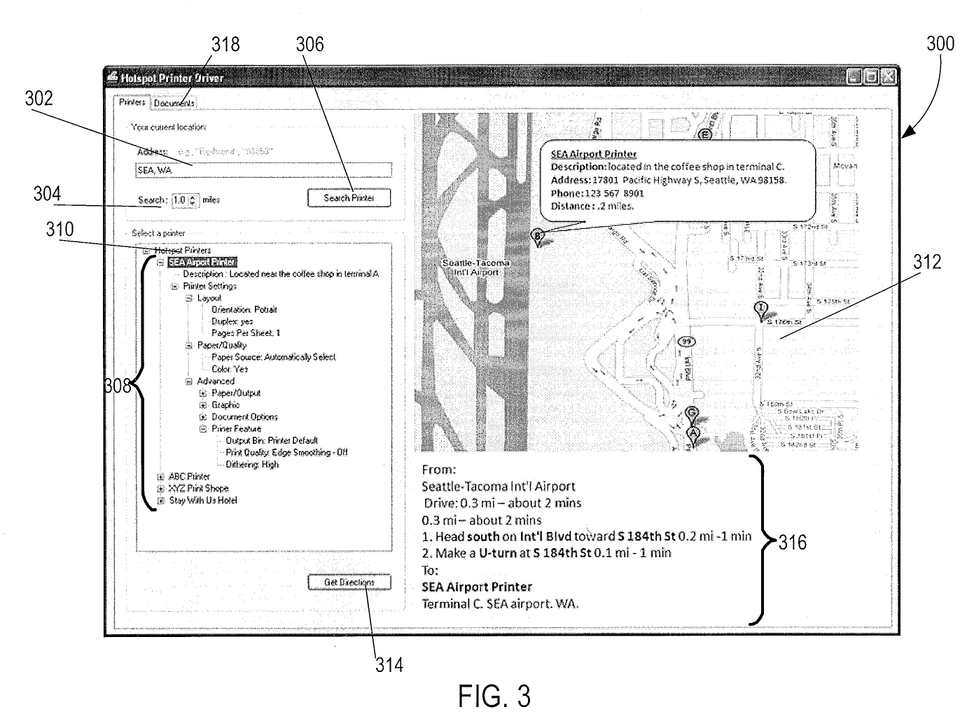

In this example, when the user selects “Hotspot Printer Driver” 206, the printer driver generates a printing device selection screen 300 as depicted in FIG. 3. Printing device selection screen 300 includes an address field 302 that allows a user to manually specify an address for a physical location and a range field 304 that allows the user to specify a range (in this example the range is specified in miles) within the physical location indicated by the address in the address field 302. Once the user has entered data into address field 302 and range field 304, the user may submit this information by clicking on “Search Printer” button 306. The submitted address and miles range information is processed by the printer driver, which sends a request to a server (such as server 108 in FIG. 1) to request for information about printing devices (also referred to as “hotspot printers” in this example), that are registered with the server and that are physically located within the user-specified range of the user-specified physical location.

In response to the request sent by the printer driver, the server sends information to the client device about “hotspot printers” that are physically located within the user-specified range of the user-specified physical location. This information is referred to as “printing device identification data” and may include: the printing devices' description, physical location, IP address, and device capabilities. A printing device's device capabilities may be described in an XML file.

The printing device identification data is processed by the printer driver, which displays the printing device identification data to the user as a list of available printers in interface 300. As depicted in FIG. 3, interface 300 includes a list of “hotspot printers” 308 (i.e. “SEA Airport Printer”, “ABC Printer”, “XYZ Print Shop”, and “Stay With Us Hotel”) in tree view. A user may select any of the “hotspot printers” 308, such as printer 310 (“SEA Airport Printer”), to expand the node in the tree for the selected printer to see additional information about the printer. For example, in FIG. 3, the node for “SEA Airport Printer” has been expanded and the expanded tree displays a description of the printing device (“Located near the coffee shop in terminal A”) and the print settings for the printing device. The print settings for a printing device are generated based on the printing device's device capabilities.

In addition, the printer driver may be configured to request, receive, and display map data for the printing devices. For example, in response to user expansion of printer 310, as depicted in FIG. 3, the printer driver sends a request to a map service for map data of the area around the physical location of printer 310. With reference to FIG. 1, a request to a map service may be a request to map server 112. When the print driver receives the requested map data, the printer driver displays the map data in user interface 300. For example, map 312 displays a map of the area around Seattle airport where printer 310 is located.

Similarly, the printer driver may be configured to request, receive, and display directions data for the printing devices. In FIG. 3, the user may indicate the he wishes to see the directions for driving to the physical location of printer 310 by first expanding the node for printer 310 and then by clicking on “Get Directions” button 314. In response, the printer driver sends a request to the map service for directions data. This request may also be directed to a map server such as map server 112 in FIG. 1. When the print driver receives the requested directions data, the print driver displays the direction data as directions (i.e. directions 316) in user interface 300. As described in more detail hereinafter, a “Documents” tab 318 displays a document selection screen that provides user access to electronic documents stored on a device, for example, electronic documents stored on a document server.

The user may successively select different remote printing devices from the list of “hotspot printers” 308 to view an expanded display of the selected printing device and to view a map and directions for the selected printing device. In addition, the print settings for a selected printing device may be modified by the user, within the limits set by the selected printing device's device capabilities. When the user decides that he or she would like to select a particular printing device for printing, the particular printing device's print settings, as modified by the user, are used by the printer driver to generate the print job.

The printer driver generates a print job that reflects the electronic document to be printed and the print settings modified by the user for the selected printing device. The electronic document to be printed may be selected by the user, and may be stored locally on the client device or remotely on a document server. Further description of the scenario where the electronic document to be printed is stored on a remote document server is provided below.

According to one embodiment, the printing devices are Web service-enabled printing devices. The World Wide Web Consortium (“W3C”) is an international consortium that develops standards for the World Wide Web. The W3C defines a “web service” as a software system that is designed to support interoperable machine-to-machine interaction over a network. This definition encompasses many different systems, but in common usage, the term refers to those services that use Simple Object Access Protocol (SOAP)-formatted Extensible Markup Language (“XML”) envelopes and that have their interfaces described using Web Services Description Language (“WSDL”). Web services allow devices and applications to communicate with each other over one or more networks without the intervention of any human being, while using the same suite of protocols (e.g., Hypertext Transfer Protocol (“HTTP”)) that a human being would use to communicate with such devices and applications over one or more networks.

Web service-enable printing devices provide a WSD (“Web Service Device”) print service. As part of providing a WSD print service, Web service-enabled printing devices perform functions such as: provide device capabilities upon request, provide default printer configuration, default status of the printer, location information such as the physical address of the device, and in some cases a user interface to allow users to interact with the devices. Print jobs submitted to Web service-enabled printing device comprise a print ticket and print data. The print ticket is in XML format and contains metadata that indicates formatting and print settings. The print data portion of the print job contains data that reflect the data in the electronic document to be printed.

According to another embodiment, the remote printing devices are not Web service-enabled printing devices. In this embodiment, the printer driver generates print jobs that may be interpreted and printed by the printing device selected for printing. For example, it is common for a non-Web-service-enabled printing device to accept print jobs that contain only print data, where the format and print settings for the print job are embedded in the print data itself. For such a printing device, the printer driver generates a print job that conforms contains only print data, with print settings embedded in the print data. Print jobs, or print data, for non-Web-Service-enabled printers are often written in common printer languages such as Printer Command Language (PCL) and Postscript (PS). Hence, the printer driver is configured to generate print jobs and print data in the PCL and PS printer languages.

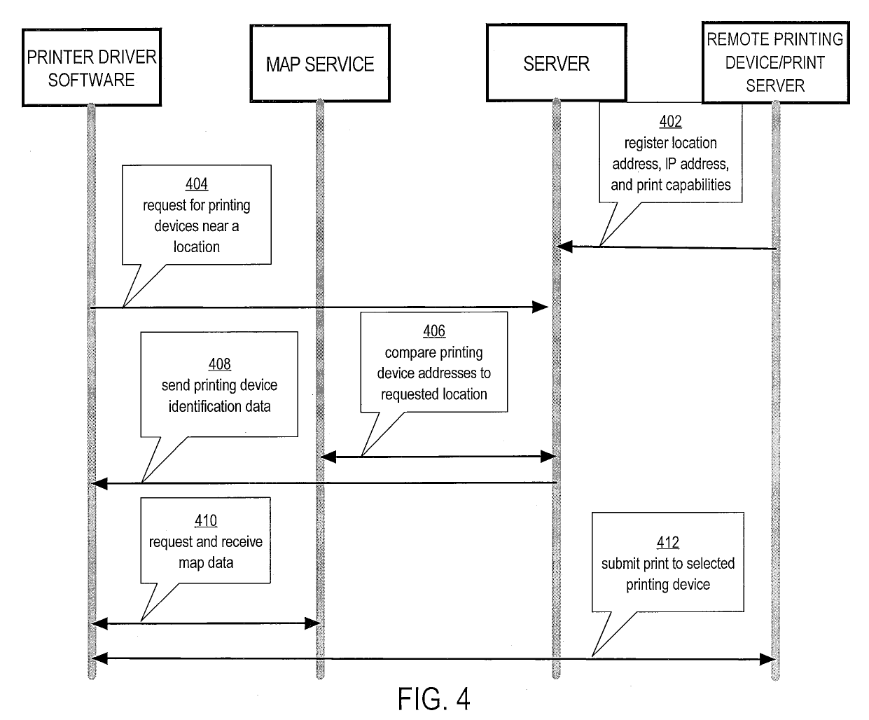

FIG. 4 is a diagram that depicts a series of communications steps performed by the various elements described above. In step 402, printing devices and/or print servers register with the server. Print server 104 in FIG. 1 is an example of a print server that may register with the server. Alternatively, individual remote printing devices may also register with the server. Server 108 in FIG. 1 is an example of a server with which printing devices and/or print servers may register. During registration, the registering printing device or print server provides information such as its IP address, physical location address, and device capabilities to the server.

In step 404, the printer driver on a client device sends a request to the server for identification of registered printing devices near a specified location. As discussed above, the specified location may be a location specified by a user of a client device (such as client device 110) through a user interface (such as user interface 300) generated by the printer driver. In response to the request, the server determines which of the registered printing devices and print servers are located near the specified location. The printer driver may also include, in its request a specified range, in which case the server determines which of the registered printing devices and print servers are located within the specific range of the specified location. In order to make this determination, the server communicates with a map service (step 406). The map service may be provided through a map server such as map server 112 in FIG. 1.

Once the server has determined which printing devices and print servers satisfy the location criteria specified by the printer driver software, the server sends printing device identification data to the printer driver software that includes information for the printing devices and print servers that satisfy the location criteria specified by the printer driver software (step 408). The printer driver may then also communicate with the map service to request and receive map data used to display maps and directions for a printing device to the user (step 410). Finally, once the user has selected a particular printing device, the printer driver software generates a print job for printing to the particular remote printing device, and submits the print job to the selected printing device (step 412).

### III. Printing Remote Documents to Remote Printing Devices

According to one embodiment, the electronic document that is printed to a remote printing device is stored on a document server, not locally on a client device. The following description discusses this embodiment in detail.

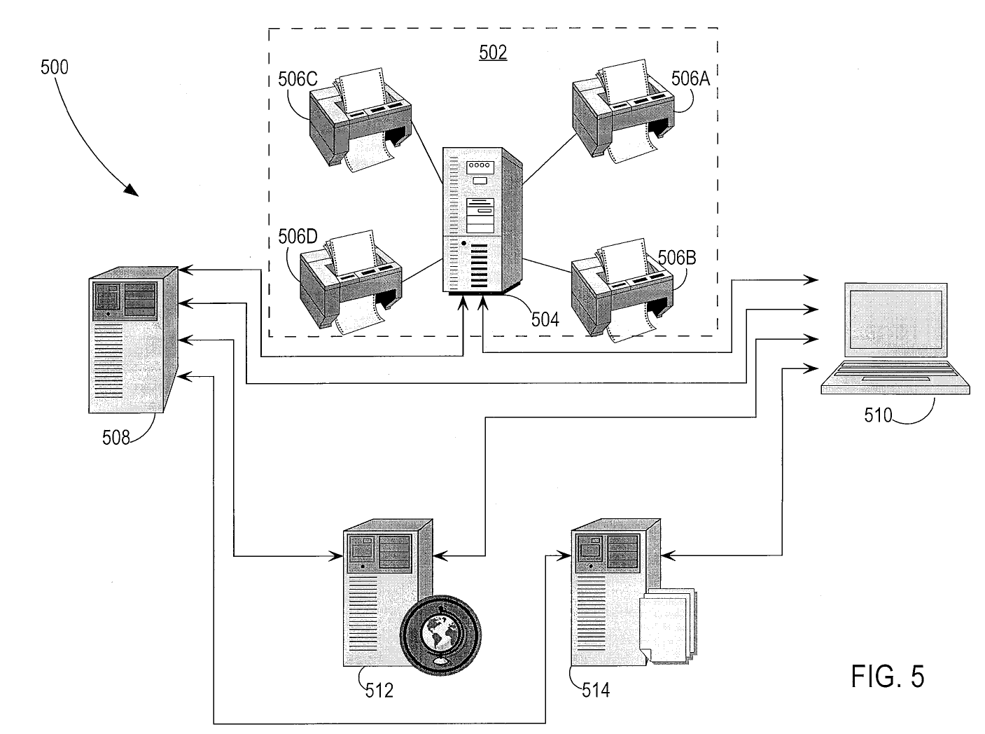

FIG. 5 is a block diagram that depicts an example arrangement 500 in which this embodiment may be implemented. FIG. 5 is similar to FIG. 1, but additionally includes a document server (514). Arrangement 500 includes a print services provider 502, a server 508, a client device 510, a map server 512, and a document server 514 that are communicatively coupled to each other via one or more communications links. The various elements in FIG. 5 may also communicate with each other via a network (not depicted), and the network may be implemented by any medium or mechanism that provides for exchange of data between the various elements.

Print services provider 502 includes print server 504 and printing devices 506A, 506B, 506C, and 506D (collectively, the printing devices 506). The print server 504 accepts print jobs on behalf of the printing devices 506 and distributes the accepted print jobs to the printing devices 506. Printing devices 506 may be any type of device that is capable of processing print jobs and generating a printed version of an electronic document reflected in the print job. Examples of printing devices 506 include, without limitation, printers, network-enabled copy machines and multi-function peripherals (MFPs), and the approaches described herein are not limited to any particular type of printing devices 506. Embodiments of the invention are described herein in the context of the four printing devices depicted in FIG. 1, but the approach is applicable to any number of printing devices disposed in the same or different physical location. In an alternative embodiment, a printing device may be directed communicatively coupled to server 508 and client 510 or the aforementioned network without the intermediate element of a print server 504 and without being included in a group of printing devices in a print services provider. In this alternative embodiment, a printing device is capable of accepting print jobs on its own behalf and processing the accepted print jobs.

Server 508 communicates with print server 504 to enable print server 504 to register printing devices (i.e., printing devices 506) with server 508. In an alternative embodiment, individual printing devices directly register with server 508. When a printing device is registered with server 508, information about the registering printing device is provided to the server 508. This information may include the printing device's IP address, device capabilities (e.g., duplex, stapler, color, etc.), and physical location. In one embodiment, during registration, a printing device provides server 508 with information specifically requested by server 508. For example, server 508 may specifically request for the registering printing device's device capabilities.

Document server 514 is a repository of electronic documents. Users may establish accounts that allow users to deposit and retrieve documents from document server 514. Such user accounts may be established as a result of users subscribing to a document storage subscription service. In establishing an account, a user usually establishes a user name and password, with which the user uses to login to his account and to access documents stored under the account on the document server. The user name and password for a user account is also referred to herein as “authentication data”. Document server 514 is depicted as a single server in FIG. 5, but may be one of multiple servers that are all accessible to a user when the user subscribes to a document storage subscription service. Also, a user may establish user accounts at multiple document servers.

Server 508 communicates with document server 514 to enable document server 514 to register with the server 508. When a document server is registered with server 508, information about the document server is provided to server 508, such as the document server's IP address.

Map server 512 is a repository of map data and provides map data to various elements (e.g., server 508 and client 510) upon request. Map server 512 may be owned or controlled by a map services provider, also referred to herein as “map service”, such as Google maps.

Client device 510 may be any type of client device, including, without limitation, a desktop computer, a laptop computer, a personal digital assistant (PDA), a mobile device and a telephony device. Client device 510 includes printer driver software (not depicted in FIG. 5. For example, client device 510 may communicate with server 508 to request information about the printing devices 506, communicate with map server 512 to request map data of a geographical area around printing device 506A, communicate with document server 514 to retrieve an electronic document, and communicate with print server 504 to submit a print job to the printing devices 506. The discussion below provides a detailed description of the techniques and processes for the client device 510 to print an electronic document located on document server 514 to the printing devices 506.

When the printer driver on client device 510 generates a print job, the print job reflects a particular electronic document that may be stored remotely at the document server 514 instead of locally on client device 510. In one embodiment, the server 508 communicates the IP address of document server 514 to the printer driver on client device 510. A user who wishes to print an electronic document that is stored on document server 514 provides authentication data (e.g., user name and password) to the printer driver on client device 510, which then sends the authentication data to the document server 514 to login to the user's account. In response, the document server 514 authenticates the user using the authentication data, and provides document identification data to the client device 510. The document identification data identifies the available electronic documents on document server 514 that may be accessed and printed by the user.

The printer driver software on client device 510 displays the available electronic documents to the user, and the user selects a particular electronic document for printing. This selection is communicated from the client device 510 to the document server 514, and the electronic document is downloaded from document server 514 to client device 510. At client device 510, after receipt of the electronic document that is to be printed, the printer driver generates a print job based on the electronic document. This print job is submitted to a selected printing device for printing.

In another embodiment, the user-provided authentication data is not communicated to the document server 514, but to server 508, which then communicates the authentication data to document server 514. Similarly, document identification data from document server 514 may be sent to the client device 510 via server 508, document selection from client device 510 may be sent to document server 514 via server 508, and the selected electronic document may be downloaded from document server 514 to client device 510 via server 508. Hence, in this embodiment, there are no direct communications between the client device 510 and the document server 514, and the server 508 acts as an intermediary node between client device 510 and document server 514.

In one embodiment, there may be multiple document servers from which a user may access electronic documents for printing. In such a case, each document server registers with the server. If there are direct communications between a client device and the multiple document servers, then the IP addresses of the documents servers may be communicated from the server to the client device and the client device may directly authenticate and communicate with each document server. Alternatively, the server may act as an intermediary between the client device and the document servers. In the case where the server acts as an intermediary, the user of a client device may provide a single set of authentication data to the server to be used as authentication data to all the document servers or multiple sets of authentication data for each of the multiple document servers.

According to one embodiment of the invention, the printer driver on a client device (e.g., client device 510) is configured to generate a graphical user interface that allows users to retrieve electronic documents from a document server (e.g., document server 514) and to access and print the electronic documents to printing devices (e.g., printing devices 506) that are registered with a server (e.g., server 508). The user interface may be implemented by any mechanism(s) and/or process(es) that allow for the exchange of information between the client device and users. Examples of user interface include, without limitation, a display, such as a cathode ray tube (CRT) or liquid crystal display (LCD), and an input device, such as a keypad, touchpad, touch screen, keyboard or mouse, or any combination of displays and input devices.

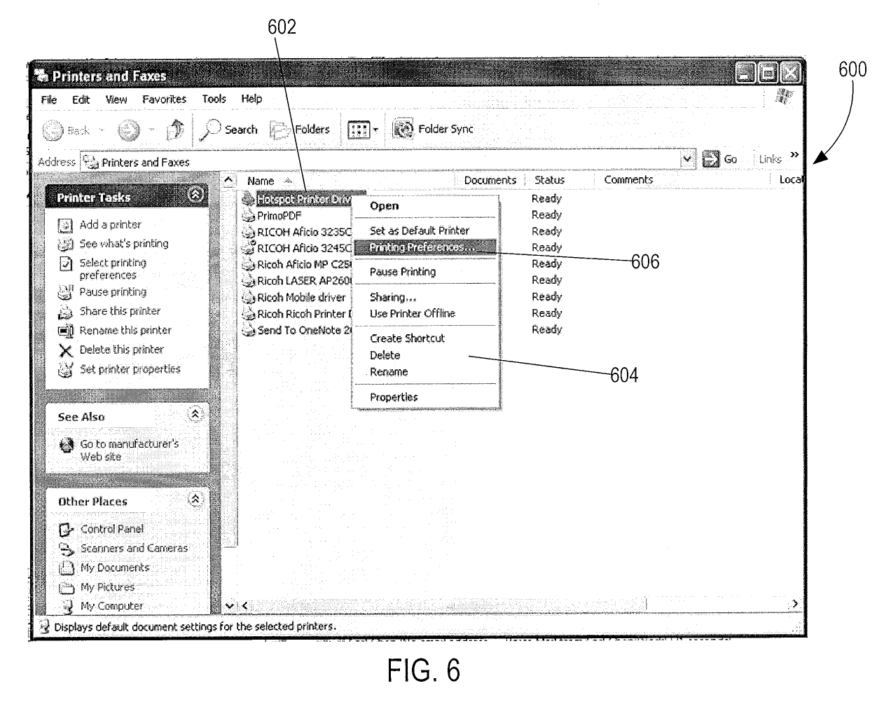

FIG. 6 depicts an example printer driver selection screen 600, where several printer drivers are listed. Printer driver “Hotspot Printer Driver” 602 is a printer driver that provides users with the ability to access and print to printing devices registered with a server and to access and download electronic documents from documents servers registered with the server. FIG. 6 depicts that a user has accessed a drop-down menu 604 associated with “Hotspot Printer Driver” 602 and has selected “Printing Preferences . . . ” menu item 606, which results in launching a printer selection screen.

An example of a printer selection screen is printer selection screen 300 in FIG. 3, which has already been discussed above. A printer selection screen, as discussed above, may also be generated in response to a user issuing a print command. A print command, however, is usually issued from inside an electronic document itself (e.g., selecting the print command from a menu in a Microsoft Word document). In the case that the electronic document is not stored locally on the user's client device and is therefore not conveniently available to the user, the selection of a printer driver software, such as “Hotspot Printer Driver” 602 in FIG. 6 just discussed above, is another way through which a user can launch a printer selection screen.

Once a printer selection screen is launched, the user may interact with the printer selection screen to specify a location and location range, retrieve a list of printers, modify printer settings, etc., as discussed above with respect to FIG. 3.

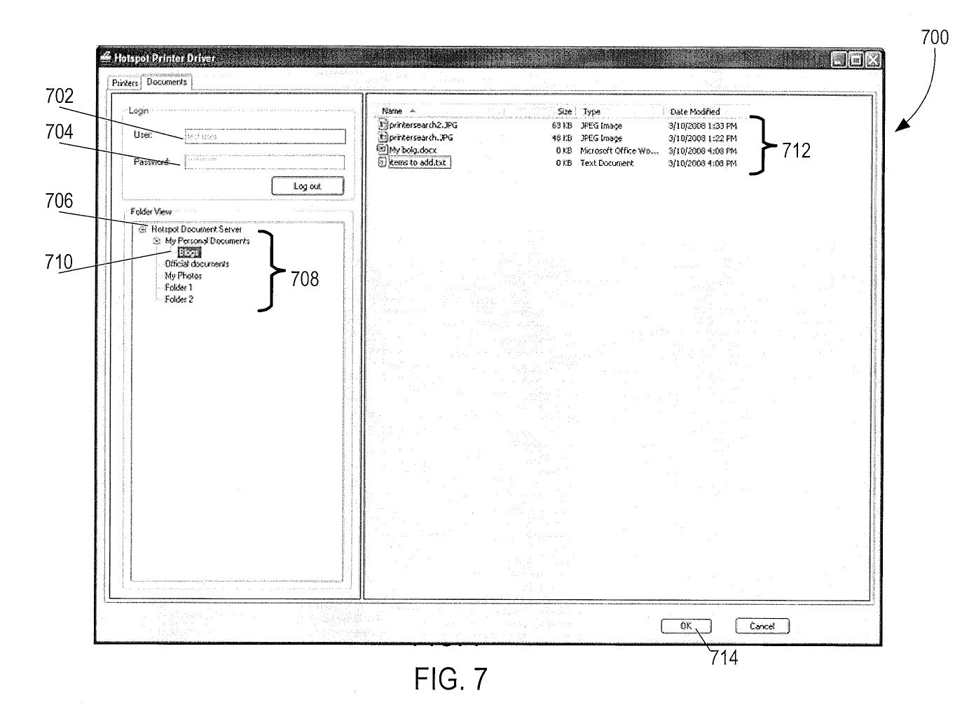

In addition, the user may launch a document selection screen, such as the document selection screen 700 in FIG. 7. Remote document selection screen 700 may be launched when a user selects the “Documents” tab 318 on printer selection screen 300.

As depicted in FIG. 7, remote document selection screen 700 contains user name field 702 and password field 704, in which a user may enter his or her user name and password. The entered user name and password, or authentication data, is processed by the printer driver and sent to a document server for authentication. As described above, the document server has previously registered with the server, and the printer driver may request the server for the IP address of the document server in order to send user authentication data to the document server. If and when the authentication data allows the user to successfully login to the document server, the document server sends information to the printer driver about which electronic documents on the document server are available to the user. The available electronic documents may be organized in folders, and the folder structure of the available electronic documents may also be communicated to the printer driver.

Information about the available electronic documents, also referred to herein as “document identification data”, is displayed by the printer driver to the user. For example, in FIG. 7, document selection screen 700 displays the name of the document server that the user has authenticated to (“Hotspot Document Server” 706) and a list of folders 708 on “Hotspot Document Server” 706 that are available to the user. Selection of a folder, such as “Blogs” folder 710 results in a display of the electronic documents 712 in the selected folder that are available to the user. At this point, the user may select a document and indicate that he or she wishes to print the selected document (for example, for clicking on “OK” button 714). In response, the printer driver generates a print job for the selected document and submits the print job to the remote printing device that the user selected on printer selection screen 300.

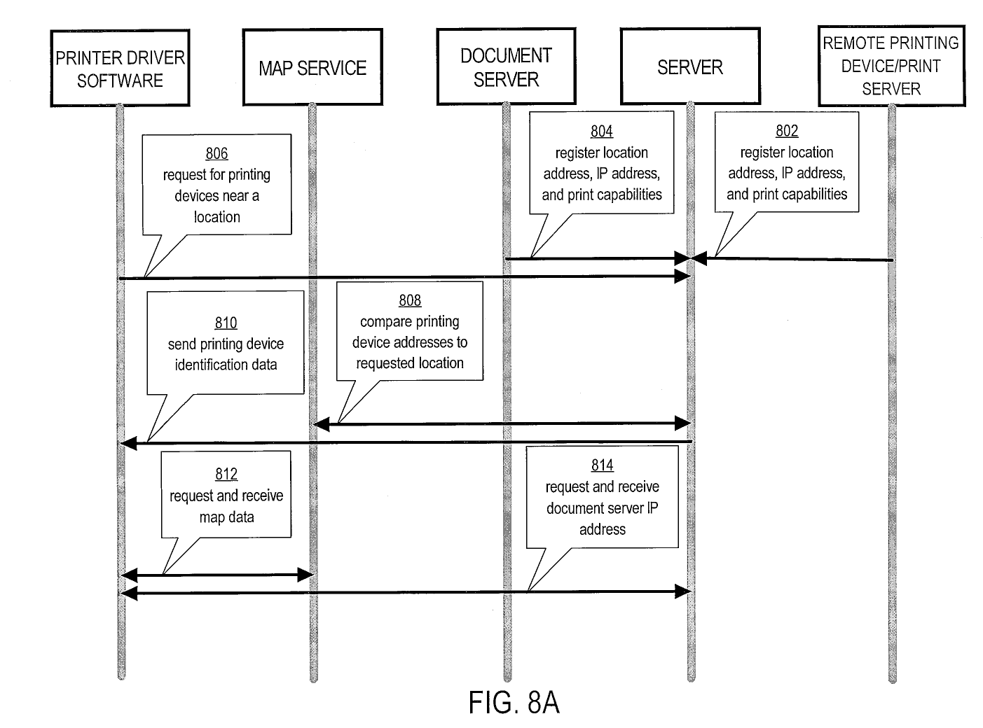

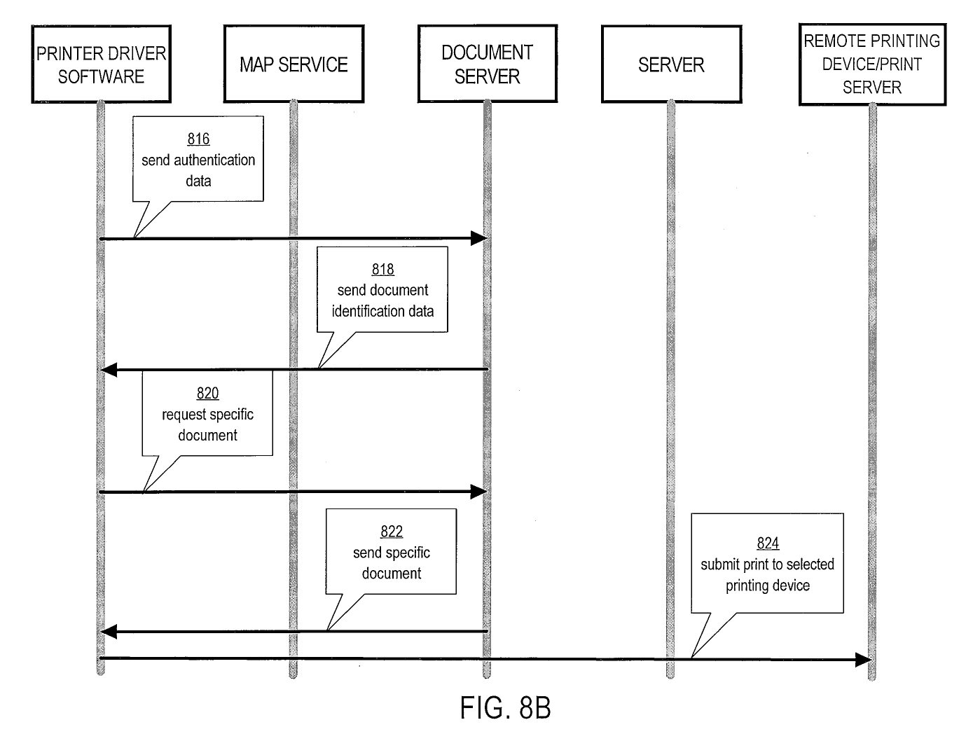

FIGS. 8A and 8B are diagrams that depict a series of steps in communications between the various elements described above. In step 802, printing devices and/or print servers register with the server. Print server 504 in FIG. 5 is an example of a print server that may register with the server. Server 508 in FIG. 5 is an example of a server with which printing devices and print servers may register. Alternatively, individual remote printing devices may also register with the server. When registering, the registering device or print server gives information about its IP address, location address, and printing capabilities to the server.

In step 804, document servers register with the server. Document server 514 in FIG. 5 is an example of a document server that may register with the server. The registering document server gives information about its IP address to the server.

In step 806, the printer driver on a client device sends a request to the server for identification of printing devices near a specified location. As already discussed above, the specified location may be a location specified by a user of the client device through a user interface generated by the printer driver software. In response to the request from the client device, the server determines which of the remote printing devices and print servers that are registered with the server are located near the specified location. The printer driver software may also have specified a specific range, in which case the server determines which of the remote printing devices and print servers that are registered with the server are located with the specific range of the specified location. In order to make this determination, the server communicates with a map service (step 808).

Once the server has determined which remote printing devices and print servers satisfy the location criteria specified by the printer driver, the server sends printing device identification data to the printer driver software that includes information for the remote printing devices and print servers satisfy the location criteria specified by the printer driver (step 810). The printer driver may then also communicate with the map service to request and receive map data that is used to display maps and directions for a remote printing device to the user (step 812).

The user may indicate that he or she wishes to print an electronic document that is located on a document server. In such a case, the printer driver software requests and receives from the printer server the IP address of the remote document server that has been registered with the server (step 814). Although in the example illustrated by FIGS. 8A and 8B, only one remote document server is registered with the server, there may be other cases where more than one document server is registered with the server and where more than one document server is available to the user.

In step 816 (FIG. 8B), the printer driver sends authentication data provided by the user to the remote document server. The document server processes the authentication data and determines which, if any, of the electronic documents stored on it are available to the user. If there are electronic documents that are available to the user, the document server communicates the identity of the available electronic documents to the printer driver (step 818). The printer driver may then display the available documents to the user in a user interface such as document selection screen 700 in FIG. 7. When the user selects a particular available electronic document for printing, the printer driver software requests the particular electronic document from the document server (step 820). The document server, in response, sends the requested electronic document to the printer driver software (step 822).

Finally, once the user has selected a particular printing device, the printer driver software generates a print job for printing the selected document to the selected printing device, and submits the print job to the selected printing device (step 824).

### IV. Printing Directly at a Printing Device

According to one embodiment, techniques are provided where a user prints an electronic document located on a remote document server to a printing device without use of a client device. These techniques are discussed in detail below.

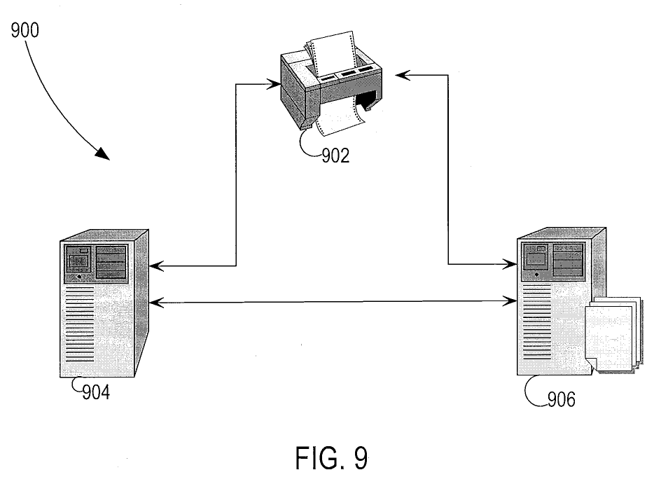

FIG. 9 is a block diagram that depicts an example arrangement 900 in which this embodiment may be implemented. Arrangement 900 includes a printing device 902, a server 904, and a document server 906 that are communicatively coupled to each other via one or more communications links. The various elements in FIG. 9 may also communicate with each other via a network (not depicted), where the network may be implemented by any medium or mechanism that provides for exchange of data between various elements.

Printing device 902 may be any type of device that is capable of processing print jobs and generating a printed version of an electronic document reflected in the print job. Examples of printing devices include, without limitation, printers, network-enabled copy achiness and multi-function peripherals (MFPs), and the approaches described herein are not limited to any particular type of printing devices.

Printing device 902 communicates with server 904 and registers with server 904. When a printing device is registered with server 904, information such as the printing device's IP address, printing capabilities (e.g., duplex, stapler, color, etc.), and physical location may be communicated to server 904. Document server 906 also communicates and registers with server 904.

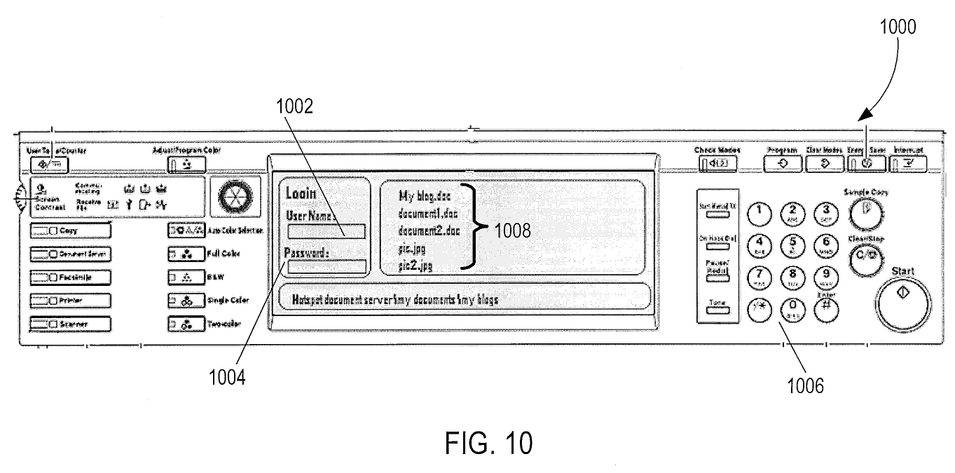

Printing device 902 includes a user interface such as user interface panel 1000 in FIG. 10. Through this user interface, a user may enter authentication data, such as a user name in user name field 1002 and password in password field 1004, by using a keypad such as keypad 1006. This authentication data is then sent from the printing device 902 to document server 906. Printing device 902 may communicate with server 904 to retrieve information about document server 906, such as document server 906's IP address, before communicating directly with document server 906. In response to receiving authentication data from printing device 902, document server 906 sends, to printing device 902, document identification information identifying which documents, if any, on document server 906 are available for the user to print. Printing device 902 may display the document identification information to the user through user interface 1000. For example, user interface 1000 includes a displayed list of documents 1008. The user may then select a particular document from the list of documents 1008 for printing. In response to user selection of a particular document, printing device 902 requests and downloads the document from document server 906, and generates a print job for printing the document. Finally, the print job is processed by the printing device 902 and printed.

In another embodiment, the printing device 902 requests the document from document server 906 in the form of a print job. In this embodiment, the document server 906 generates a print job for printing the selected document to printing device 902, and sends this print job to the printing device 902 for printing.

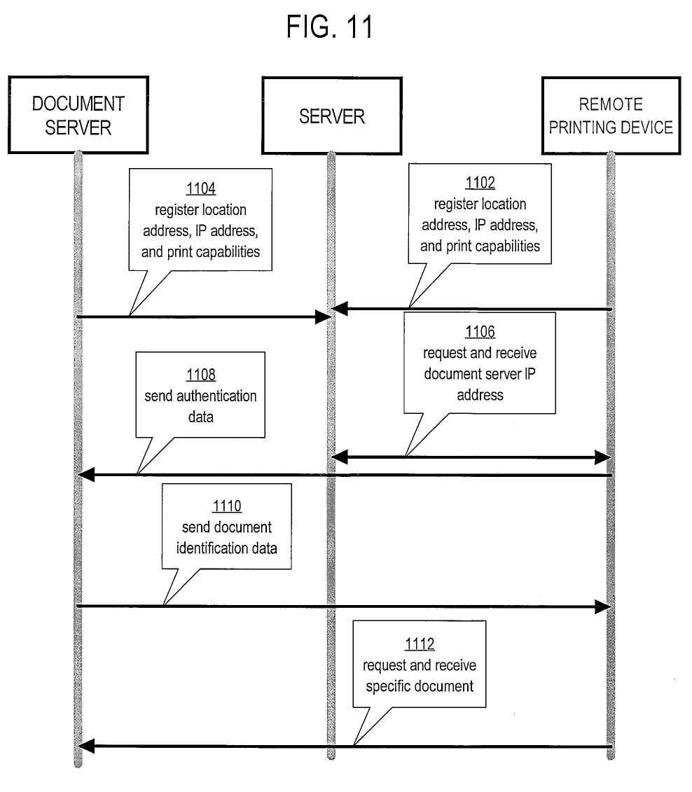

FIG. 11 is a diagram that depicts a series of steps in communications between the various elements described above. In step 1102, printing devices register with the server. Printing device 902 in FIG. 9 is an example of a remote printing device that may register with the server. Server 904 in FIG. 9 is an example of a server with which remote printing devices may register with. In step 1104, document servers, such as document server 906 in FIG. 9, also register with the server.

In step 1106, the printing device requests and receives a document server's IP address from the server. This step may be performed in response to a user indicating that he or she wishes to print a document stored on the document server. For example, the user may have used a user interface like user interface panel 1000 in FIG. 10 to enter authentication data for logging on to the document server.

In step 1108, the printing device sends the user-entered authentication data to the document server. In response, the document server sends document identification data to the remote printing device that indicates which documents are available for printing (step 1110). At this point, the document identification data may be displayed to the user. If the user selects a particular document for printing, then the printing device requests the particular document from the document server (step 1112). The document is received from the document server (step 1112), and the remote printing device may then proceed to generate a print job for the document.

### V. Implementation Mechanisms

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

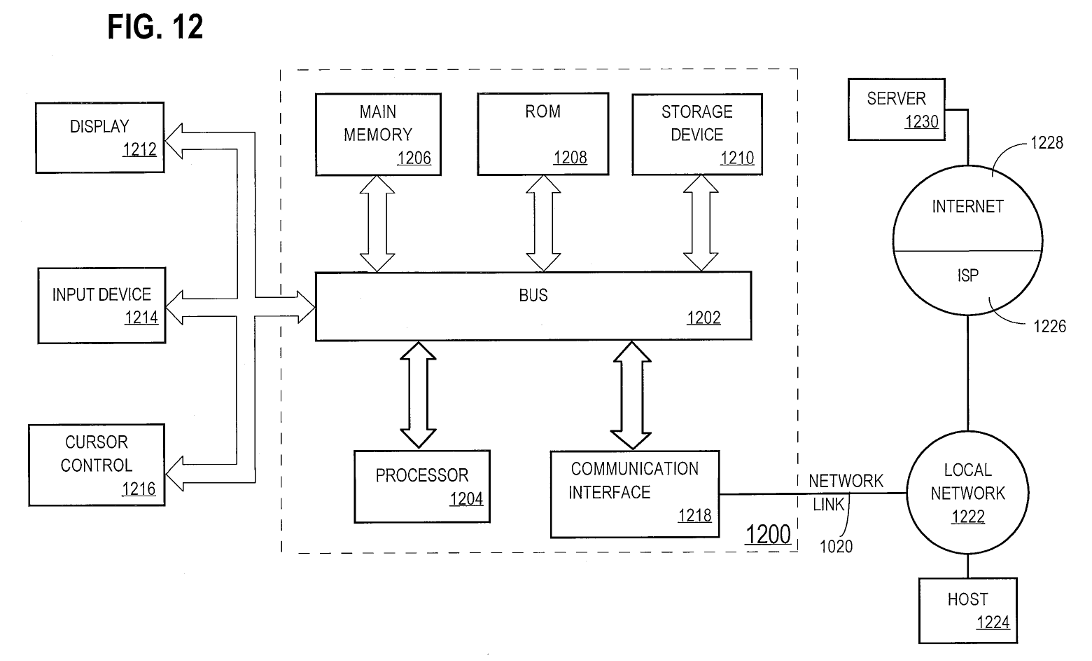

FIG. 12 is a block diagram that depicts an example computer system 1200 upon which embodiments of the invention may be implemented. Computer system 1200 includes a bus 1202 or other communication mechanism for communicating information, and a processor 1204 coupled with bus 1202 for processing information. Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic or computer software which, in combination with the computer system, causes or programs computer system 1200 to be a special-purpose machine. According to one embodiment of the invention, those techniques are performed by computer system 1200 in response to processor 1204 executing one or more sequences of one or more instructions contained in main memory 1206. Such instructions may be read into main memory 1206 from another computer-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 1200, various computer-readable media are involved, for example, in providing instructions to processor 1204 for execution. Such a medium may take many forms, including but not limited to, non-volatile media and volatile media. Non-volatile media includes, for example, optical or magnetic disks, such as storage device 1210. Volatile media includes dynamic memory, such as main memory 1206. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218. The received code may be executed by processor 1204 as it is received, and/or stored in storage device 1210, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for printing an electronic document, comprising:
at a client device, sending a request to a server,
wherein the request includes user address data that indicates a physical location;
at the client device, receiving, from the server, printing device identification data that identify one or more printing devices that are located within a proximity of the physical location;
at the client device, displaying the printing device identification data;
at the client device, receiving user input that indicates a selection of a particular printing device from the one or more printing devices;
at the client device, generating a print job for the electronic document; and
at the client device, sending the print job to the particular printing device.

2. The computer-implemented method of claim 1, further comprising:
at the client device, receiving, from the server, printing device address data that indicates, for each printing device of the one or more printing devices, an associated printer device physical location;
at the client device, in response to receiving user input that indicates the selection of the particular printing device:
sending, to a map service, a portion of the printing device address data that indicates a printer device physical location that is associated with the particular printing device;
receiving, from the map service, map data for a geographic area around the printer device physical location that is associated with the particular printing device;
displaying, based on the map data, a map of the geographic area around the printer device physical location that is associated with the particular printing device.

3. The computer-implemented method of claim 2, further comprising:
at the client device, in response to receiving user input that indicates the selection of the particular printing device:
sending, to the map service, a request for directions to the printer device physical location that is associated with the particular printing device from the physical location indicated by the user address data;
receiving, from the map service, directions data indicating directions to the printer device physical location that is associated with the particular printing device from the physical location indicated by the user address data; and
displaying the directions data indicating directions to the printer device physical location that is associated with the particular printing device from the physical location indicated by the user address data.

4. The computer-implemented method of claim 1, further comprising:
at the client device, receiving, from the server, device capability data for the one or more printing devices;
at the client device, in response to receiving user input that indicates the selection of the particular printing device, displaying, based on the device capability data, print settings for the particular printing device;
wherein generating the print job for the electronic document includes generating the print job based on the print settings for the particular printing device.

5. The computer-implemented method of claim 4, wherein the user input is a first user input, further comprising:
at the client device, receiving second user input that indicates user modifications to the print settings for the particular printing device; and
at the client device, modifying, before generating the print job, the print settings for the particular printing device based on the second user input.

6. The computer-implemented method of claim 1, wherein the electronic document is selected by a user.

7. The computer-implemented method of claim 6, wherein the user input is a first user input, further comprising:
at the client device, receiving second user input that includes user authentication data;
at the client device, authenticating the user to one or more document servers by sending the user authentication data to the one or more document servers;
at the client device, receiving, from the one or more document servers, document identification data that identifies one or more documents stored on the one or more document servers that are accessible by the user;
at the client device, displaying, to the user, the document identification data;
at the client device, receiving third user input that indicates a selection of a particular document from the one or more documents as the electronic document to be printed;
wherein the particular document is stored on a particular document server of the one or more document servers;
at the client device, requesting the particular document from the particular document server; and
at the client device, receiving, from the particular document server, the particular document.

8. The computer-implemented method of claim 6, wherein the user input is a first user input, further comprising:
at the client device, receiving second user input that includes user authentication data;
at the client device, authenticating the user to one or more document servers by sending the user authentication data to the server;
at the client device, receiving, from the server, document identification data that identifies one or more documents stored on the one or more document servers that are accessible by the user;
at the client device, displaying, to the user, the document identification data;
at the client device, receiving third user input that indicates a selection of a particular document from the one or more documents as the electronic document to be printed;
at the client device, sending a request for the particular document to the server; and
at the client device, receiving, from the server, the particular document.

9. A computer-implemented method for printing an electronic document, comprising:
at a printing device:
receiving, from a user, a first user input that includes user authentication data;
authenticating the user to a document server by sending the user authentication data to the document server;
receiving, from the document server, document identification data that identifies one or more documents that are accessible by the user;
displaying, to the user, the document identification data;
receiving, from the user, a second user input that indicates a selection of a particular document from the list of one or more documents as the electronic document to be printed; and
printing the electronic document.

10. The computer-implemented method of claim 9, further comprising:
at the printing device:
requesting the particular document from the document server;
receiving, from the document server, the particular document; and
generating a print job for the particular document;
wherein printing the electronic document includes processing the print job for the particular document.

11. The computer-implemented method of claim 9, further comprising:
at the printing device:
requesting a print job for the particular document from the document server; and
receiving, from the document server, the print job for the particular document;
wherein printing the electronic document includes processing the print job for the particular document.

12. A computer-readable medium storing instructions for printing an electronic document, the instructions including instructions which, when executed by one or more processors, cause:
at a client device, sending a request to a server,
wherein the request includes user address data that indicates a physical location;
at the client device, receiving, from the server, printing device identification data that identify one or more printing devices that are located within a proximity of the physical location;
at the client device, displaying the printing device identification data;
at the client device, receiving user input that indicates a selection of a particular printing device from the one or more printing devices;
at the client device, generating a print job for the electronic document; and
at the client device, sending the print job to the particular printing device.

13. The computer-readable storage medium of claim 12, further comprising instructions which, when executed by the one or more processors, cause:
at the client device, receiving, from the server, printing device address data that indicates, for each printing device of the one or more printing devices, an associated printer device physical location;
at the client device, in response to receiving user input that indicates the selection of the particular printing device:
sending, to a map service, a portion of the printing device address data that indicates a printer device physical location that is associated with the particular printing device;
receiving, from the map service, map data for a geographic area around the printer device physical location that is associated with the particular printing device;
displaying, based on the map data, a map of the geographic area around the printer device physical location that is associated with the particular printing device.

14. The computer-readable storage medium of claim 13, further comprising instructions which, when executed by the one or more processors, cause:
at the client device, in response to receiving user input that indicates the selection of the particular printing device:
sending, to the map service, a request for directions to the printer device physical location that is associated with the particular printing device from the physical location indicated by the user address data;
receiving, from the map service, directions data indicating directions to the printer device physical location that is associated with the particular printing device from the physical location indicated by the user address data; and
displaying the directions data indicating directions to the printer device physical location that is associated with the particular printing device from the physical location indicated by the user address data.

15. The computer-readable storage medium of claim 12, further comprising instructions which, when executed by the one or more processors, cause:
at the client device, receiving, from the server, device capability data for the one or more printing devices;
at the client device, in response to receiving user input that indicates the selection of the particular printing device, displaying, based on the device capability data, print settings for the particular printing device;
wherein generating the print job for the electronic document includes generating the print job based on the print settings for the particular printing device.

16. The computer-readable storage medium of claim 15, further comprising instructions which, when executed by the one or more processors, cause:
at the client device, receiving second user input that indicates user modifications to the print settings for the particular printing device; and
at the client device, modifying, before generating the print job, the print settings for the particular printing device based on the second user input.

17. The computer-readable storage medium of claim 12, wherein the electronic document is selected by a user.

18. The computer-readable storage medium of claim 17, wherein:
the user input is a first user input, and
the computer-readable medium further comprises instructions which, when executed by the one or more processors, cause:
at the client device, receiving second user input that includes user authentication data;
at the client device, authenticating the user to one or more document servers by sending the user authentication data to the one or more document servers;
at the client device, receiving, from the one or more document servers, document identification data that identifies one or more documents stored on the one or more document servers that are accessible by the user;
at the client device, displaying, to the user, the document identification data; at the client device, receiving third user input that indicates a selection of a particular document from the one or more documents as the electronic document to be printed;
wherein the particular document is stored on a particular document server of the one or more document servers;
at the client device, requesting the particular document from the particular document server; and
at the client device, receiving, from the particular document server, the particular document.

19. The computer-readable storage medium of claim 17, wherein the user input is a first user input, further comprising instructions which, when executed by the one or more processors, cause:
at the client device, receiving second user input that includes user authentication data;
at the client device, authenticating the user to one or more document servers by sending the user authentication data to the server;
at the client device, receiving, from the server, document identification data that identifies one or more documents stored on the one or more document servers that are accessible by the user;
at the client device, displaying, to the user, the document identification data;
at the client device, receiving third user input that indicates a selection of a particular document from the one or more documents as the electronic document to be printed;
at the client device, sending a request for the particular document to the server; and
at the client device, receiving, from the server, the particular document.

20. An apparatus for printing an electronic document, the apparatus comprising:
a user interface; and
a print driver configured to:
send a request to a server, wherein the request includes user address data that indicates a physical location,
receive, from the server, printing device identification data that identifies one or more printing devices that are located within a proximity of the physical location,
cause the printing device identification data to be displayed on the user interface,
detect, via the user interface, user input that indicates a selection of a particular printing device from the one or more printing devices,
generate a print job for the electronic document, and
cause the print job to be sent to the particular printing device.
